(19) United States
(12) Patent Application Publication
(10) Pub. No.: US 2005/0023107 A1
(43) Pub. Date: Feb. 3, 2005

(54) Drive equipment for escalator step or moving walkway plate

(76) Inventor: Michael Matheisl, Wien (AT)

Correspondence Address: Jay A. Bondell, Esq.;SCHWEITZER CORNMAN GROSS & BONDELL LLP, 292 Madison Avenue, New York, NY, 10017, US

(21) Appl. No.: 10/896,093

(22) Filed: Jul. 20, 2004

(30) Foreign Application Priority Data
Jul. 31, 2003 (EP) 03405569.9
Mar. 1, 2004 (EP) 04405121.7

(51) Int. Cl. B66B 23/02

(52) U.S. Cl. 198/330; 198/333

(57) ABSTRACT

An escalator or moving walkway has a step belt or plate of motor-driven steps or plates and free-running steps or plates. Running rails are arranged upon transverse elements of a support construction, and have a respective running surface for step rollers and a running surface for chain rollers. The step rollers are connected with the step or plate body by means of arms. A secondary part of a linear motor is connected to the step or plate body by means of pins. A guide rail for guidance and drive of the steps or plates is centrally provided along a forward running part or return running part of the escalator or walkway, wherein the primary part of the linear motor is integrated in the guide rail. Each motor step or plate is provided with a brake which acts on the guide rail.

The present invention relates to an escalator or moving walkway having a support construction, a step belt with motor-driven steps and free-running steps or a plate belt with motor-driven plates and free-running plates for the transport of persons and/or articles and a balustrade mounted by means of a balustrade base, and having a handrail.

### BACKGROUND OF THE INVENTION

An escalator has become known from laid-open specification JP 2001163562 in which the individual steps of the step belt are provided with a drive. The drive comprises an electric motor which is integrated in the step body and which at each side drives a leading and a trailing axle, wherein gearwheels arranged at ends of the axle engage stationary racks. The current feed for the electric motor takes place by means of power rails and wiper contacts.

The two gearwheels provided per step cause excessive noise when meshing with the racks. The step has to be precisely guided so that the gearwheels cleanly engage the racks. Moreover, such a drive mechanism with pulleys, belts or chains, axles, gearwheels and racks is mechanically complicated, expensive and high in maintenance. Problems with synchronism arise due to the driven step rollers and the driven chain rollers.

The present invention provides a remedy to the shortcomings of the prior art. It is accordingly a purpose of the present invention to avoid the disadvantages of the known equipment and to create drive equipment which, in a simple mode and manner, drives a step or a plate of, respectively, a step belt or a plate belt.

### BRIEF DESCRIPTIONS OF THE INVENTION

In accordance with the foregoing and other objects and purposes, the present invention comprises a drive in the form of a linear motor in which a guide rail is preferably a part of the motor. The power transmission required for forward drive of the step or the plate takes place at a point which ensures that the step or the plate cannot be tilted by the drive. Only a few additional escalator or moving walkways parts are necessary for motorizing the steps or plates. The centrally arranged travel track or guide rail for progression of the motor-driven step also serves as a brake rail for the brake provided for each motor-driven step.

The motorization of the step by means of a linear motor represents a significant simplification and improvement of the drive system. The linear motor offers a direct build up of power, high speed and high acceleration, as well as a high degree of static and dynamic load rigidity. Moreover, the linear motor is a maintenance-free and play-free drive. The simple constructional of a linear motor, particularly with a flattened synchronous motor system, excited by permanent magnets, with a primary part and secondary parts provides precise and quick positioning of the motor step.

Due to the uncomplicated, simple mounting of the motor-driven step or the motor-step valuable working time can be saved. A motor step according to the invention is very economical by virtue of the few and simple parts required. Accordingly, the new motor step is simpler, lighter, cheaper and less complicated than conventional constructions. Quicker and easier mounting and demounting is an additional advantage of the motor step according to the invention.

### BRIEF DESCRIPTION OF THE DRAWINGS

The invention is explained in more detail in the following on the basis of drawings showing an illustrative embodiment, in which:

FIG. 1 shows a side view of an escalator incorporating the invention;

FIG. 2 is an elevation view of a motor-driven step in accordance with the invention;

FIG. 3 is a side view of the step belt with a motor-driven step and free-running steps;

FIG. 4 shows the motor-driven step with support magnets in the motor region; and

FIG. 5 shows the motor-driven step with support magnets in the motor region and in the roller region.

### DETAILED DESCRIPTION OF THE INVENTION

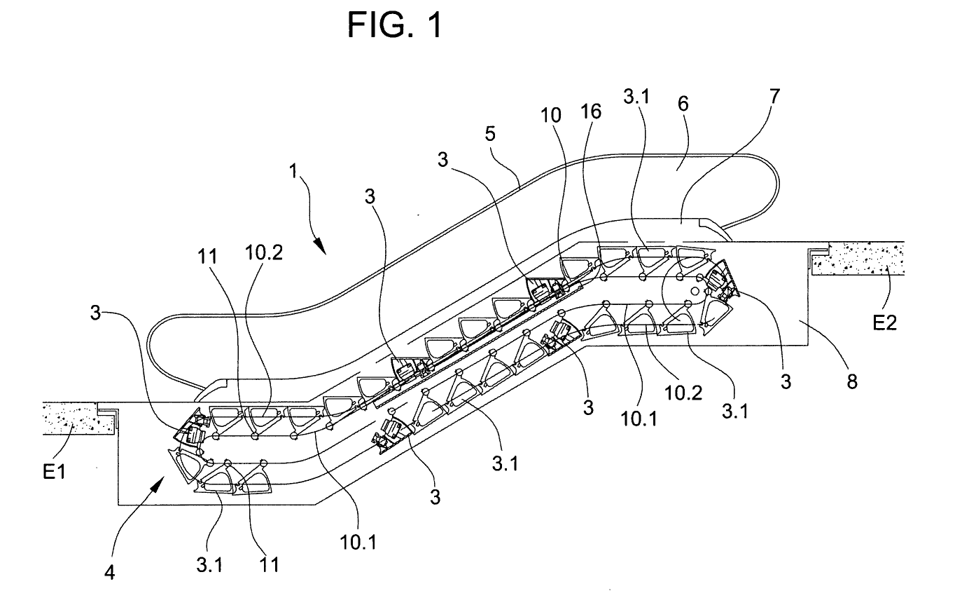

FIG. 1 shows an escalator 1, which connects a first floor E1 with a second floor E2, or a moving walkway, with a step belt 4 consisting of motor-driven steps 3 and free-running steps 3.1. It is to be recognized that an analogous construction is employed in the case of a moving walkway, wherein the references 3 and 3.1 refer to motor-driven and free-running plates, respectively, with a moving walkway consisting of plates. Depending on the respective escalator or moving walkway, a motor-driven step or plate 3 is provided for, for example, every three to twelve or more free-running steps or plates 3.1. A handrail 5 is arranged at a balustrade 6, which is mounted at the lower end by means of a balustrade base 7. The balustrade base 7 is supported by a support construction 8 of the escalator 1 or moving walkway.

In the further course of description there is used, instead of the expression “escalator or moving walkway”, merely “escalator”, but the embodiments apply in like sense also to a moving walkway.

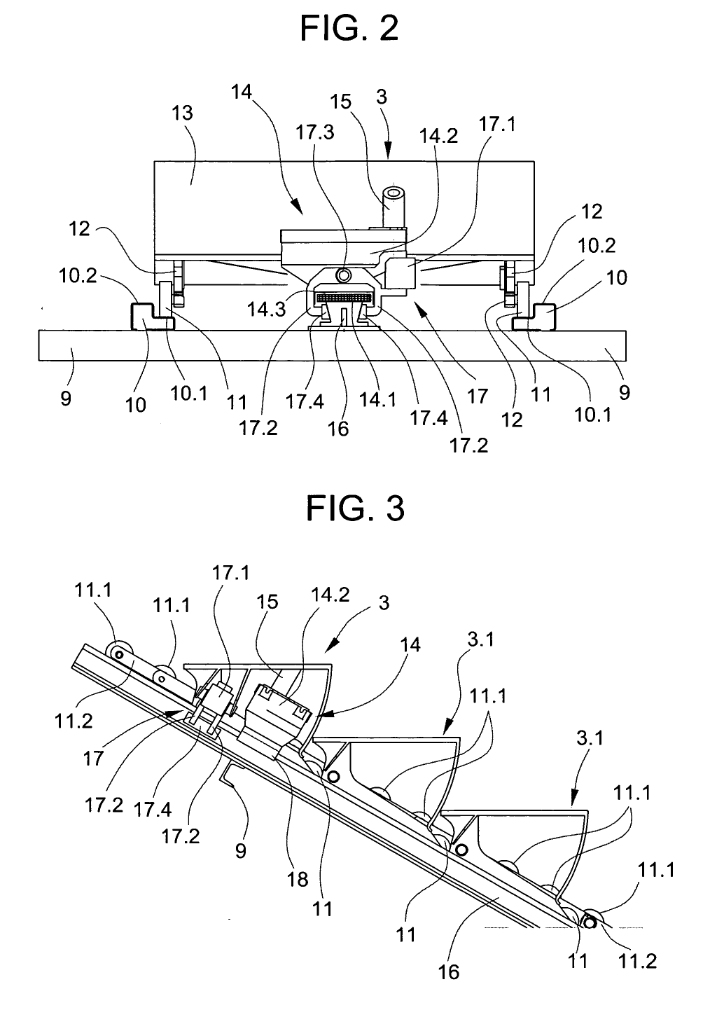

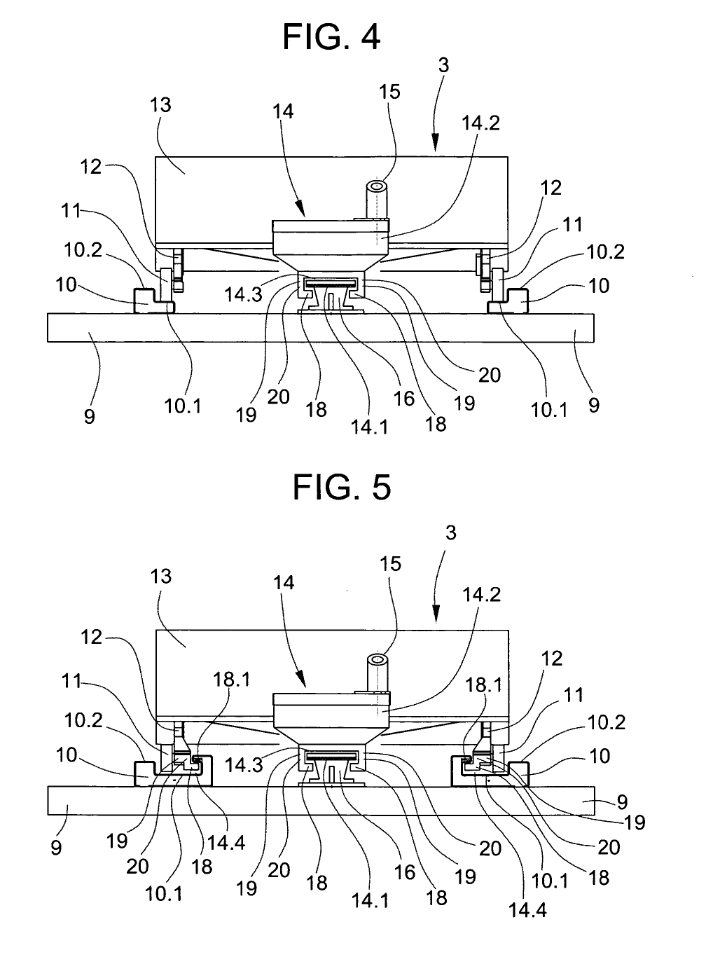

FIG. 2, FIG. 3, FIG. 4 and FIG. 5 show details of the motor-driven step 3 or the free-running step. Running rails 10 are arranged at transverse beams 9 of the support construction 8 and each has a respective running surface 10.1 for the step rollers 11 and a running surface 10.2 for chain rollers 11.1 of a step belt 11.2. The running surface 10.1 for the step rollers 11 and a running surface 10.2 for the chain rollers 11.1 are separately provided in the turn-around region and in the horizontal region of the escalator. The step rollers 11 are connected with the step body 13 by means of arms 12. The secondary part 14.2 of a linear motor 14 is connected to the step body 13 by means of step pins 15. A travel track 16 or a guide rail 16, which serves for guidance and drive of the step 3, is centrally provided along the forward running part or return running part of the escalator 1 upon the transverse girders 9. The primary part 14.1 of the linear motor 14 is integrated in the guide rail 16.

The linear motor 14 comprises primary part 14.1 with wound stator lamination stacks (longitudinal stator) and secondary part 14.2 with permanent magnets (magnet strip). The primary part or longitudinal stator 14.1 is integrated in the guide rail 16. The linear motor 14 operates as a conventional electric motor with the distinction that the stator is disposed in a divided and extended form along the entire guide rail 16. Instead of a rotary magnetic field, an electric current generates, by means of the primary part 14.1, a travelling magnetic field which draws the motor step 3 along behind as if by an invisible cord. The motor speed can be steplessly regulated by the frequency of the current by means of frequency converters. A change in force direction of the travelling field turns the energy-consuming motor into an energy-delivering generator, which provides contactless braking of the motor step 3.

As a variant, the primary part 14.1 of the linear motor 14 can be arranged at the step body 13 and the secondary part 14.2 of the linear motor 14 can be arranged at the guide rail 16.

The motor step 3 is constructed to be floating, wherein the step 3 floats by means of regulable electromagnets or support magnets 18. The support magnets 18 are arranged on support arms 19 and are positioned under the longitudinal stator 14.1. Lateral guide magnets 20 are also provided at the support arms 19. The lateral guide magnets 20 keep the motor step 3 in the track. When current is supplied, the support magnets 18 are drawn from below upwardly towards the ferromagnetic stator packets of the longitudinal stator 14.1 and the motor step is thus set into a floating state. The motor step thus does not need much energy to float. Due to this modest demand, the floating system could also derive its energy need from a battery system which provides current and is charged during step travel. Thus, the motor step itself could still float for some time at standstill. The gap width or clear air gap 14.3 between primary part 14.1 and secondary part 14.2 is one to two millimetres and is maintained even during loading of the motor-driven step 3 by means of the regulable support magnets 18, wherein the signal of a gap width sensor is detected by means of a regulator, which controls the support magnets during drive.

As a variant, at least one support magnet 18 can be arranged above the guide rail 16 at the secondary part 14.2, in which case the support arms 19 are redundant.

In the case of the motor step 3 shown in FIG. 5 the step body 13 is constructed to be floating in both the linear motor region and the roller region. The non-motorized or free-running steps 3.1 are also constructed to be floating in the roller region. Guide magnets 20 for lateral guidance and support magnets 18, which ensure the clear air gap 14.3 in the linear motor region and the clear air gap 14.4 in the roller region and which are arranged at support arms 19 engaging under running rails 10, as well as under the longitudinal stator 14.1 are provided, wherein the guide rail 16 is constructed to be somewhat higher. The step rollers 11 and the chain rollers 11.1 are lifted off the running surfaces 10.1 and 10.2 along the guide rail 16. In the end region of the guide rail 16 the air gap 14.3 or 14.4 is regulated in such a manner that the rollers 11, 11.1 are either lifted off the running rail 10 or placed on the running rail 10. Relieving cams of plastic material or steel can be provided to produce a soft, sliding placement of the rollers 11, 11.1.

The gap width or the clear air gap 14.3 between primary part 14.1 and secondary part 14.2 is one to two millimetres and is maintained by means of the regulable support magnets 18 even during loading of the motor-driven step 3, wherein the signal of a gap width sensor is detected by means of a regulator which controls the support magnets 18 during drive. The same applies to the air gap 14.4. When feed current is supplied, the support magnets 18 are drawn from below towards ferromagnetic stator lamination packets 18.1 and the motor-driven step 3 or the free-running step 3.1 is thus set into a floating state.

Each motor step 3 is provided with a brake 17, which acts on the guide rail 16 or running rail 10. The brake 10 consists of a brake magnet 17.1 which releases brake pincers 17.2 which are normally applied against the rail by a spring force, wherein the brake pincers 17.2 are movable about an axis 17.3 of rotation. Brake jaws 17.4 of the brake 17 produce a braking force against both sides of the guide rail 16. In the case of an emergency stop or an unallowed downward movement of the step belt 15, the brake pincers engage under spring loading against the travel track 16 or the guide rail 16.

The current supply of the motor step 3 can be ensured, for example, along the travel track or guide rail 16, which is provided in the forward running part or in the return running part of the escalator 1, by means of contactless, inductive energy transmission. A stationary primary part induces energy at a secondary part which travels together with the motor-driven step 3 and to which a battery and/or the brake magnet 17.1 is or are connected. Control signals are transmitted by radio to or from the motor-driven step 3.

The current supply can also be ensured by means of wiper contacts or brushes guided along a power rail.

The integration of the longitudinal stator 14.1 in the guide rail 16 offers advantages. On the one hand, it is only necessary to supply current to the part of the travel path of the escalator 1 at which the motor step 3 is instantaneously disposed. That saves current and energy. On the other hand, the motor power is adaptable and is also sufficient for heavy-duty escalator construction in the field of underground and suburban railways.

Due to the low friction losses, the low guide resistance or travel resistance and the high degree of efficiency of the longitudinal stator linear motor 14, the motor step 3 uses substantially less energy than a conventional escalator motor. Moreover, escalators with the motor step 3 according to the invention have, for the same speed, by virtue of the floating principle, substantially improved quietness during running than conventional escalators.

1. An escalator or moving walkway consisting of a support construction, a belt construction for the transport of persons and/or articles chosen from the group consisting of a step belt with at least one motor-driven step with a step body and free-running steps and a plate belt with at least one motor-driven plate with a plate body and free-running plates, and a balustrade mounted to the support construction by means of a balustrade base and having a handrail, characterized in that a linear motor is provided for drive of the motor-driven step or plate, wherein a guide rail is a part of the linear motor.

2. The escalator or moving walkway according to claim 1, characterized in that the linear motor comprises a primary part and a secondary part, the primary part being arranged at the guide rail and the secondary part being arranged at the step or plate body.

3. The escalator or moving walkway according to claim 1, characterized in that the linear motor comprises a primary part and a secondary part, the primary part being arranged at the step or plate body and the secondary part being arranged at the guide rail.

4. The escalator or moving walkway according to claim 2 or 3, characterized in that the primary part comprises a longitudinal stator with wound stator lamination stacks and the secondary part comprises a magnet strip with permanent magnets.

5. The escalator or moving walkway according to claim 1, 2 or 3, further comprising support magnets to suspend the motor driven step or plate.

6. The escalator or moving walkway according to claim 4, further comprising support magnets to suspend the motor driven step or plate.

7. The escalator or moving walkway according to claim 6, characterized in that the support magnets are arranged at support arms under the longitudinal stator, and guide magnets for lateral guidance are provided at the support arms.

8. The escalator or moving walkway according to claim 6, characterized in that the support magnets are arranged above the guide rail at the secondary part of the linear motor.

9. The escalator or moving walkway according to claim 1, 2 or 3, characterized in that brake pincers of a brake are arranged at the motor driven step or plate and engage the guide rail or a running rail.

10. The escalator or moving walkway according to claim 1, 2 or 3, characterized in that the guide rail is provided in a forward running part or a return running part of the escalator or moving walkway.

11. The escalator or moving walkway according to claim 1, 2 or 3, characterized in that a current supply means is provided along the guide rail.

12. An escalator or moving walkway consisting of a support construction, a belt construction for the transport of persons and/or articles chosen from the group consisting of a step belt with steps comprising at least one motor-driven step and free-running steps and a plate belt with plates comprising at least one motor-driven plate and free-running plates, and a balustrade mounted to the support construction by means of a balustrade base and having a handrail, and support magnets for suspending the steps or plates.

13. The escalator or moving walkway according to claim 12, characterized in that the support magnets are arranged on support arms under running rails, and guide magnets for lateral guidance are provided at the support arms.

14. The escalator or moving walkway according to claim 13, characterized in that ferromagnetic stator lamination stacks are arranged at the running rails for drawing the support magnets from below during a current feed to place the steps plates into a floating state.
